(19) United States
(12) Patent Application Publication
(10) Pub. No.: US 2018/0032465 A1
(43) Pub. Date: Feb. 1, 2018

(54) METHOD FOR PROVIDING GRAPHICAL PANEL OF DOCKING DEVICE AND DOCKING DEVICE THEREOF

(71) Applicant: I/O INTERCONNECT, LTD., SANTA ANA, CA (US)

(72) Inventors: Chih-Hsiung CHANG, TAIPEI (TW); Hsiang-Ling WANG, TAIPEI (TW)

(21) Appl. No.: 15/729,708

(22) Filed: Oct. 11, 2017

Related U.S. Application Data
(63) Continuation-in-part of application No. 15/213,396, filed on Jul. 19, 2016.
(60) Provisional application No. 62/342,224, filed on May 27, 2016.

(51) Int. Cl. G06F 13/40; G06F 13/10

(52) U.S. Cl. CPC G06F 13/4081; G06F 13/102; G06F 2213/0042

(57) ABSTRACT

Present disclosure relates to a method for providing graphical panel of a docking device and the docking device thereof. The method includes following steps: electrically coupling the docking device having ports to a first device having a display, wherein some indicators corresponding to the ports are provided on the docking device; and providing a graphical panel having a first contour corresponding to a second contour of the docking device, wherein some virtual indicators are positioned on the graphical panel corresponding to the visual indicators.

### CROSS-REFERENCE TO RELATED APPLICATION

This application is a Continuation-in-part of U.S. application Ser. No. 15/213,396, filed on Jul. 19, 2016, which claims priority of U.S. Provisional Application Ser. No. 62/342,224, filed on May 27, 2016, the entirety of which is incorporated by reference herein.

### BACKGROUND

### Field of Invention

The present disclosure relates to a method for operating an interface device and the interface device thereof. More particularly, present disclosure relates to a method for providing graphical panel of a docking device and the docking device thereof.

### Description of Related Art

Thanks to the improvements of USB technology, more and more interface devices are provided to people. However, most of current interface devices are used as simple intermediates for connecting with peripheral devices. Few innovative ideas are applied to make the operations more intuitive or more convenient when an interface device is in connection with other devices. Therefore, how to provide a more efficient and user-friendly interface device is a challenge to people in the art.

### SUMMARY

The invention provides a method for providing graphical panel of a docking device. The method comprises following steps: electrically coupling the docking device having at least one visual indicator to a first device having a display, wherein the at least one visual indicator is provided corresponding to at least one port of the docking device; and providing a graphical panel having a first contour corresponding to a second contour of the docking device on the display, wherein the graphical panel includes at least one virtual indicator, and the at least one virtual indicator is corresponding to the at least one visual indicator.

Another aspect of present disclosure is to provide a docking device. The docking device comprises at least one port, at least one visual indicator and a processor.

The at least one port is configured to couple to a first device having a display and at least one peripheral device. The at least one visual indicator is provided corresponding to the at least one port. The processor is in connection with the at least one port, the processor is configured to provide a graphical panel having a first contour corresponding to a second contour of the docking device on the display, wherein the graphical panel includes at least one virtual indicator, and the at least one virtual indicator is corresponding to the at least one visual indicator.

It is to be understood that both the foregoing general description and the following detailed description are by examples, and are intended to provide further explanation of the invention as claimed.

### BRIEF DESCRIPTION OF THE DRAWINGS

The invention can be more fully understood by reading the following detailed description of the embodiment, with reference made to the accompanying drawings as follows:

FIG. 1 is a schematic diagram of a docking device according to some embodiments of the present disclosure;

FIG. 2 is a schematic diagram of a docking device associated with a laptop according to some embodiments of the present disclosure;

FIG. 3 is a schematic diagram of a graphical panel corresponding to a docking device according to some embodiments of the present disclosure;

FIG. 4 is a schematic diagram of a graphical panel corresponding to a docking device according to some embodiments of the present disclosure;

FIG. 5 is a schematic diagram of a graphical panel corresponding to a docking device according to some embodiments of the present disclosure; and

FIG. 6 is a flow chart of a method for providing graphical panel of a docking device according to some embodiments of the present disclosure.

### DETAILED DESCRIPTION

Reference will now be made in detail to the present embodiments of the invention, examples of which are illustrated in the accompanying drawings. Wherever possible, the same reference numbers are used in the drawings and the description to refer to the same or like parts.

The terms used in this specification generally have their ordinary meanings in the art and in the specific context where each term is used. The use of examples in this specification, including examples of any terms discussed herein, is illustrative only, and in no way limits the scope and meaning of the disclosure or of any exemplified term. Likewise, the present disclosure is not limited to various embodiments given in this specification.

As used herein, the terms “comprising,” “including,” “having,” and the like are to be understood to be open-ended, i.e., to mean including but not limited to.

Reference throughout the specification to “one embodiment” or “an embodiment” means that a particular feature, structure, implementation, or characteristic described in connection with the embodiment is included in at least one embodiment of the present disclosure. Thus, uses of the phrases “in one embodiment” or “in an embodiment” in various places throughout the specification are not necessarily all referring to the same embodiment. Furthermore, the particular features, structures, implementation, or characteristics may be combined in any suitable manner in one or more embodiments.

In the following description and claims, the terms “coupled” and “connected”, along with their derivatives, may be used. In particular embodiments, “connected” and “coupled” may be used to indicate that two or more elements are in direct physical or electrical contact with each other, or may also mean that two or more elements may be in indirect contact with each other. “Coupled” and “connected” may still be used to indicate that two or more elements cooperate or interact with each other.

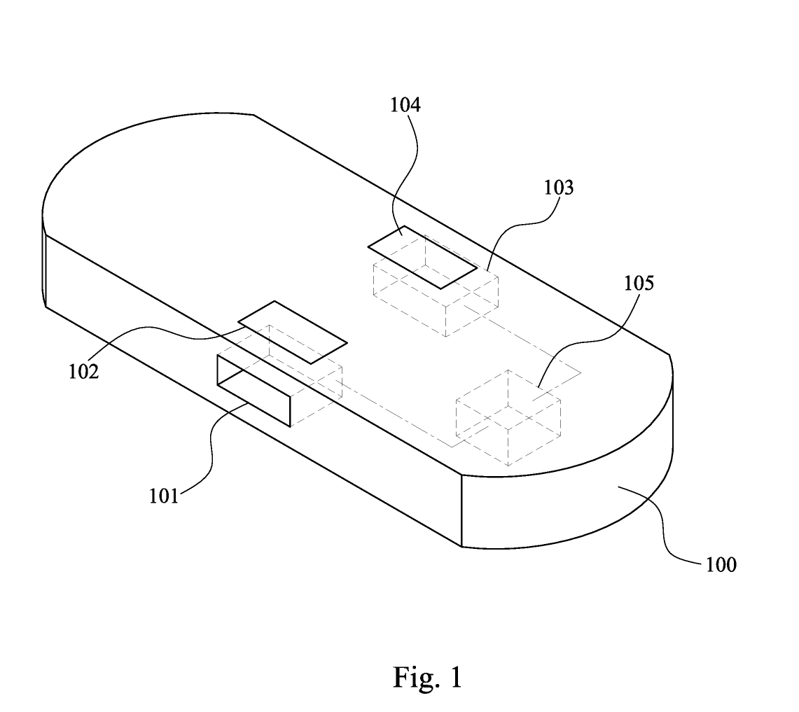

FIG. 1 is a schematic diagram of a docking device according to some embodiments of the present disclosure. A docking device 100 provided with a contour is illustrated in the embodiment. A first port 101 and a second port 103 are provided on the docking device 100 for being coupled to some peripheral devices. The first port 101 and the second port 103 are in connection with a processor 105. Two visual indicators, a first visual indicator 102 and second visual indicator 104, are disposed on the docking device 100. The first visual indicator 102 is provided to indicate an operation of a peripheral device being coupled to the first port 101. The second visual indicator 104 is provided to indicate an operation of a peripheral device being coupled to the second port 103.

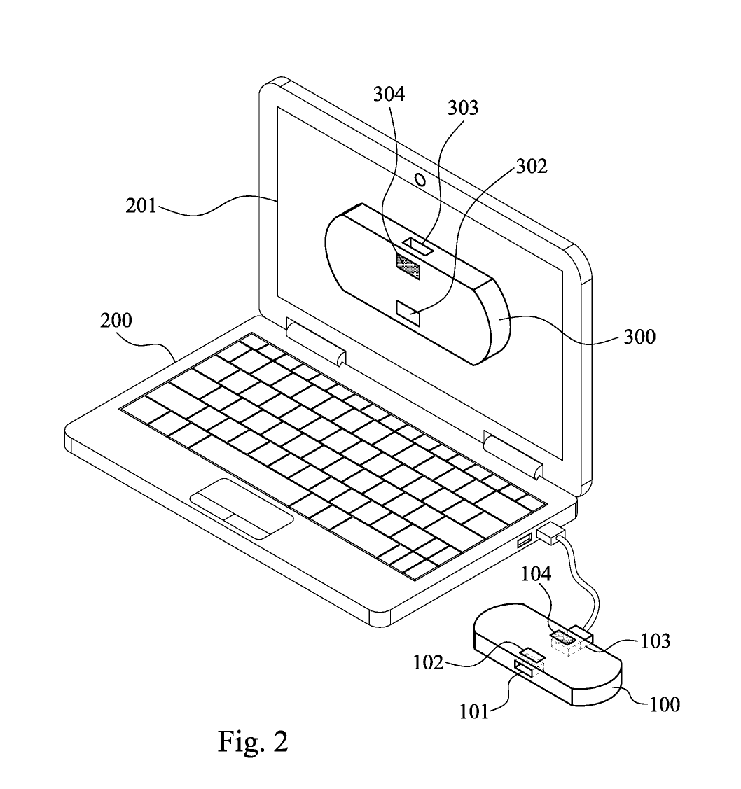

FIG. 2 is a schematic diagram of a docking device associated with a laptop according to some embodiments of the present disclosure. The docking device 100 is coupled to a laptop 200 via a cable, wherein the cable is being connected from the laptop 200 to the second port 103 of the docking device 100. Since the second port 103 is connected to the laptop 200, the second visual indicator 104 may be turned on to green, which indicates that the second port 103 is in occupation. A display 201 is provided on the laptop 200 for displaying operations of the laptop 200 to a user. In the embodiment, when the docking device 100 being coupled to the laptop 200, a graphical panel 300 is provided, by the processor 105, on the display 201. The graphical panel 300 is displayed with a contour corresponding to the contour of the docking device 100. In the embodiment, the graphical panel 300 is being displayed in a three-dimensional manner corresponding to the genuine contour of the docking device 100.

In the embodiment, a first virtual indicator 302 and a second virtual indicator 304 are positioned on the graphical panel 300 in the same manner with the configuration of the two visual indicators disposed on the docking device 100. The first virtual indicator 302 is displayed according to an operating status of the first visual indicator 102, wherein the operating status is determined by the operation of the peripheral device being coupled to the first port 101. The second virtual indicator 304 is displayed according to an operating status of the second visual indicator 104, wherein the operating status is determined by the operation of the peripheral device being coupled to the second port 103. Since the second visual indicator 104 of the docking device 100 is green at the moment, the second virtual indicator 304 may display green as well. The green light of the second virtual indicator 304 is displayed for showing a virtual port 303, which is corresponding to the second port 103 of the docking device 100, is being occupied by the laptop 200. In general, the graphical panel 300 is a visual user interface prepared for the user to control the docking device 100 and the peripheral devices being coupled to the docking device 100.

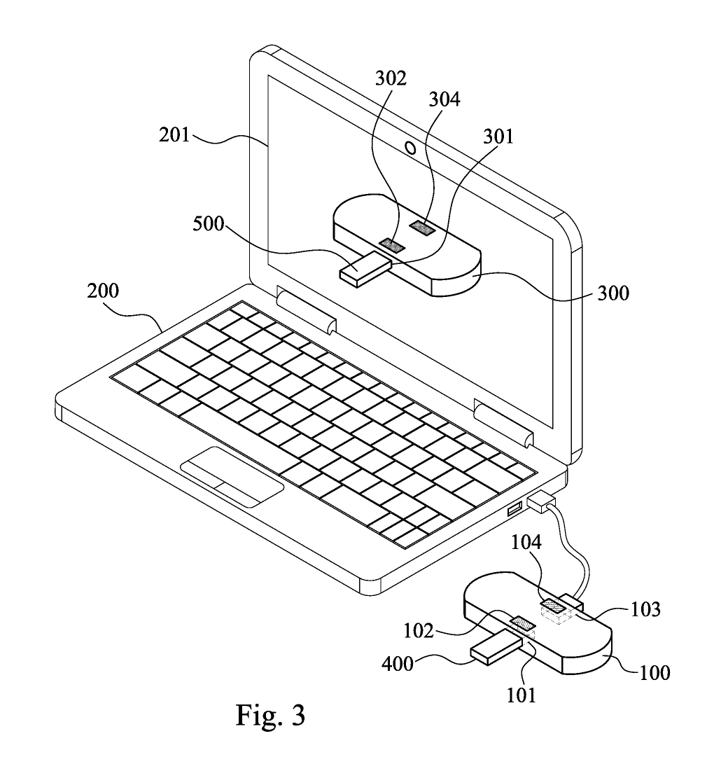

FIG. 3 is a schematic diagram of a graphical panel corresponding to a docking device according to some embodiments of the present disclosure. As illustrated in FIG. 2, when the docking device 100 being coupled to the laptop, the graphical panel 300 may be displayed on the display 201. Moreover, the first port 101 of the docking device 100 is being coupled to a flash drive 400 in the embodiment of FIG. 3. When the flash drive 400 is physically connected to the first port 101 of the docking device 100, the graphical panel 300 may illustrate the connection on the display 201. As shown in FIG. 3, when flash drive 400 is physically connected to the first port 101, the first visual indicator 102 corresponding to the first port 101 may be turned on to green. The graphical panel 300 on the display 201 may be rotated to one specific side for showing the user a virtual port 301 is being plug-in by a virtual flash drive 500, and the first virtual indicator 302 may display green as well. The virtual flash drive 500 is being displayed in a three-dimensional manner according to the contour of flash drive 400.

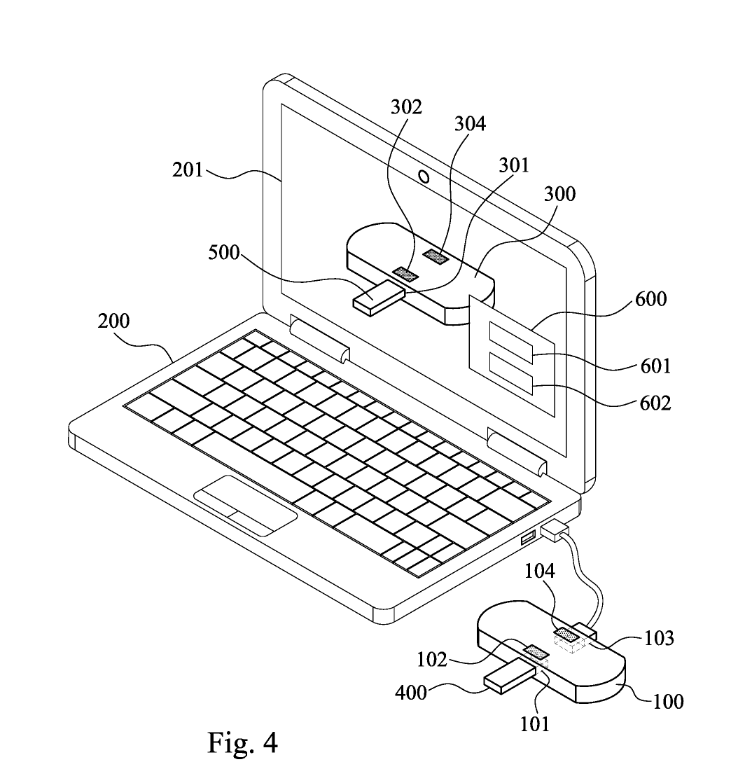

FIG. 4 is a schematic diagram of a graphical panel corresponding to a docking device according to some embodiments of the present disclosure. According to the embodiment shown in FIG. 2, the graphical panel 300 on the display 201 may be rotated to show the connection between the virtual port 301 and the virtual flash drive 500 when the flash drive 400 is connected to the first port 101 of the docking device 100. Moreover, in the meantime that the flash drive 400 being connected to the docking device 100, a notification window 600 may be provided on the display 201. The notification window 600 having two options, a first option 601 and a second option 602, is provided around the virtual port 301. The notification window 600 is provided with respect to the operation of the flash drive 400 being coupled to the first port 101. The notification window 600 is also provided with respect to the operation going to be applied to the flash drive 400. For instance, since the flash drive 400 being coupled to the first port 101 is a storage device, the first option 601 may indicate “open flash drive”, and the second option 602 may indicate “security scan flash drive”. If the user selects the first option 601, the laptop 200 may be triggered to communicate to the processor 105 for retrieving data hierarchies of the flash drive 400. The laptop 200 may display a file folder regards to the data stored in the flash drive 400 on the display 201 afterward. If the user selects the second option 602, the laptop 200 may be triggered to communicate to the processor 105 for applying available malware scan to the flash drive 400. The laptop 200 may display a scan result on the display 201 after the scanning.

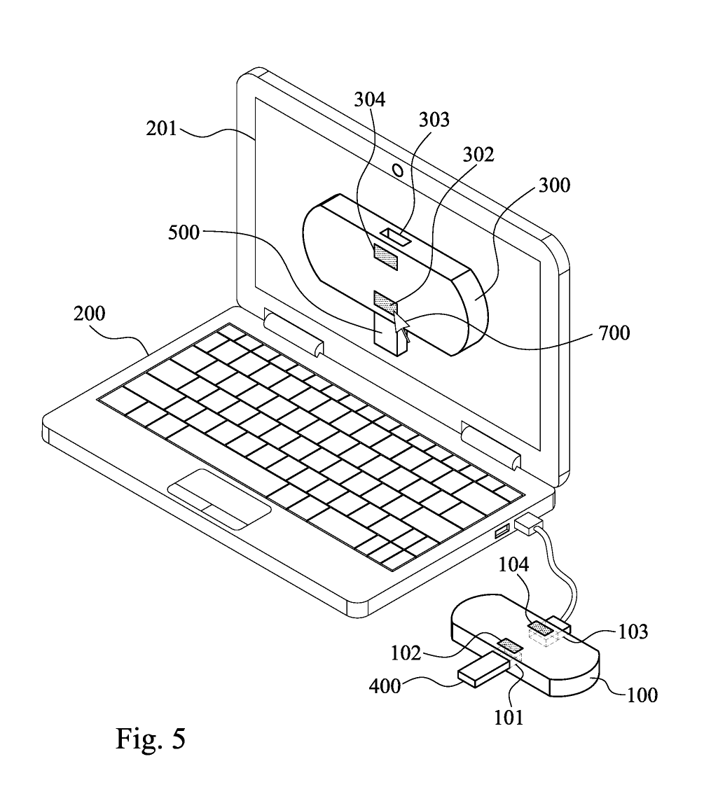

FIG. 5 is a schematic diagram of a graphical panel corresponding to a docking device according to some embodiments of the present disclosure. In the embodiment, the graphical panel 300 connected with the virtual flash drive 500 is displayed on the display 201. The first virtual indicator 302 provided on the graphical panel 300 indicates the operations of the peripheral devices being coupled to the docking device 100 via the first port 101. In the same manner, the second virtual indicator 304 provided on the graphical panel 300 indicates the operations of the peripheral devices being coupled to the docking device 100 via the second port 103. According to the status of the visual indicators disposed on the docking device 100, the first virtual indicator 302 and the second virtual indicator 304 may display as blinking, maintaining, color changing, pattern changing, being turning on and being turning off. By checking the display of the first virtual indicator 302 and the second virtual indicator 304, the user may know the status of the docking device 100 and the peripheral device being coupled to the docking device 100 via the first port 101 and the second port 103.

According to FIG. 2-4, the flash drive 400 is connected to the docking device 100 via the first port 101 so the first visual indicator 102 may maintain a green light. The first virtual indicator 302 corresponding to the first visual indicator 102 should maintain a green light accordingly. Moreover, the first virtual indicator 302 is controllable to the laptop 200, which enables the laptop 200 to control the operation of the peripherals device being coupled to the docking device 100. As shown in FIG. 5, a cursor 700 is provided on the display 201. The user may manipulate the cursor 700 to control the graphical panel 300, especially to the first virtual indicator 302. When the user moves the cursor 700 to click on the first virtual indicator 302, the graphical panel 300 may provide available operation to be applied to the flash drive 400. Since the flash drive 400 is a storage device, the available operations may be “open flash drive”, “security scan flash drive” or “eject flash drive”. The available operations may be provided with a notification window similar to the notification window 600 in FIG. 4 or other alternatives.

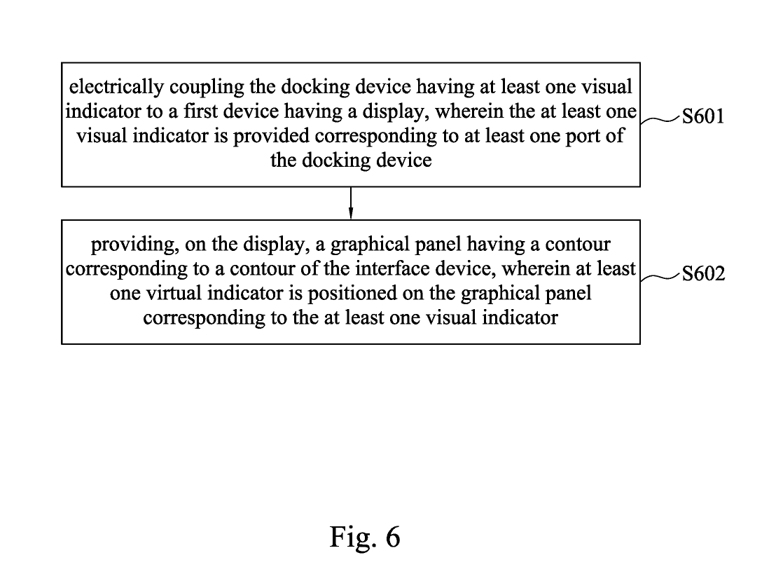

FIG. 6 is a flow chart of a method for providing graphical panel of a docking device according to some embodiments of the present disclosure. The steps of the method will be listed and explained in detail in following segments.

Step S601: electrically coupling the docking device having at least one visual indicator to a first device having a display, wherein the at least one visual indicator is provided corresponding to at least one port of the docking device. As shown in FIG. 1 and FIG. 2, the docking device 100 having the contour may be electrically coupled to the laptop 200, wherein the docking device 100 may be provided with the first visual indicator 102 and the second visual indicator 104.

Step S602: providing, on the display, a graphical panel having a contour corresponding to a contour of the docking device, wherein at least one virtual indicator is positioned on the graphical panel corresponding to the at least one visual indicator. As shown in FIG. 2-5, the graphical panel 300 may be provided on the display 201 of the laptop 200, wherein the graphical panel 300 may be provided with the contour corresponding to the contour of the docking device 100. Moreover, the graphical panel 300 may be displayed in a three-dimensional manner corresponding to the contour of the docking device 100. The graphical panel 300 is provided as a visual user interface for the user to control the docking device 100 and the peripheral devices being coupled to the docking device 100.

Although the present invention has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims.

What is claimed is:

1. A method for providing graphical panel of a docking device, comprising:
electrically coupling the docking device having at least one visual indicator to a first device having a display, wherein the at least one visual indicator is provided corresponding to at least one port of the docking device; and
providing, on the display, a graphical panel having a first contour corresponding to a second contour of the docking device, wherein the graphical panel includes at least one virtual indicator, and the at least one virtual indicator is corresponding to the at least one visual indicator.

2. The method of claim 1, further comprising:
providing at least one virtual peripheral device being coupled to the graphical panel when at least one peripheral device is coupled to the docking device via the at least one port.

3. The method of claim 2, wherein the at least one virtual peripheral device is displayed with a third contour corresponding to a fourth contour of the at least one virtual peripheral device.

4. The method of claim 2, further comprising:
providing, on the graphical panel, at least one virtual port corresponding to the at least one port being coupled to the at least one peripheral device, wherein the at least one virtual port is displayed as being coupled to the at least one virtual peripheral device.

5. The method of claim 4, further comprising:
providing, on the graphical panel, at least one notification window around the at least one virtual port being coupled to the at least one virtual peripheral device, wherein the at least one notification window is provided with respect to an operation of the at least one peripheral device.

6. The method of claim 5, wherein the at least one notification window displayed on the graphical panel is controllable to the first device, which enables the first device to control the operation of the at least one peripheral device being coupled to the at least one port.

7. The method of claim 1, wherein the graphical panel is displayed in a three-dimensional manner corresponding to the second contour of the docking device.

8. The method of claim 1, wherein the at least one virtual indicator is displayed according to an operating status of the at least one visual indicator, and the operating status is determined by at least one peripheral device being coupled to the at least one port.

9. The method of claim 8, wherein the at least one virtual indicator displayed on the graphical panel is controllable to the first device, which enables the first device to control an operation of the at least one peripheral device being coupled to the at least one port.

10. The method of claim 8, wherein the operating status of the at least one visual indicator includes blinking, maintaining, color changing, pattern changing, turning on and turning off

11. A docking device, comprising:
at least one port, configured to couple to a first device having a display and at least one peripheral device;
at least one visual indicator corresponding to the at least one port; and
a processor connected to the at least one port, configured to provide a graphical panel having a first contour corresponding to a second contour of the docking device on the display, wherein the graphical panel includes at least one virtual indicator, and the at least one virtual indicator is corresponding to the at least one visual indicator.

12. The docking device of claim 11, wherein at least one virtual peripheral device is displayed as being coupled to the graphical panel when the at least one peripheral device is coupled to the docking device via the at least one port.

13. The docking device of claim 12, wherein the at least one virtual peripheral device is displayed with a third contour corresponding to a fourth contour of the at least one virtual peripheral device.

14. The docking device of claim 12, wherein at least one virtual port is displayed as being coupled to the graphical panel when the at least one port is coupled to the at least one peripheral device correspondingly.

15. The docking device of claim 14, wherein at least one notification window is displayed around the at least one virtual port being coupled to the at least one virtual peripheral device, and the at least one notification window is provided with respect to an operation of the at least one peripheral device.

16. The docking device of claim 15, wherein the at least one notification window displayed on the graphical panel is controllable to the first device, which enables the first device to control the operation of the at least one peripheral device being coupled to the at least one port.

17. The docking device of claim 11, wherein the graphical panel is displayed in a three-dimensional manner corresponding to the second contour of the docking device.

18. The docking device of claim 11, wherein the at least one virtual indicator is displayed according to an operating status of the at least one visual indicator, and the operating status is determined by at least one peripheral device being coupled to the at least one port.

19. The docking device of claim 18, wherein the at least one virtual indicator displayed on the graphical panel is controllable to the first device, which enables the first device to control an operation of the at least one peripheral device being coupled to the at least one port.

20. The docking device of claim 18, wherein the operating status of the at least one visual indicator includes blinking, maintaining, color changing, pattern changing, turning on and turning off.
